(19) United States
(12) Patent Application Publication
(10) Pub. No.: US 2014/0330180 A1
(43) Pub. Date: Nov. 6, 2014

(54) POUCH CONTAINING LIQUID WITH THERAPEUTIC EFFECT

(71) Applicant: Chin-Yu Huang, Taipei (TW)

(72) Inventor: Chin-Yu Huang, Taipei (TW)

(73) Assignee: TAIWELL TECH. CO.,LTD., Taipei (TW)

(21) Appl. No.: 14/269,063

(22) Filed: May 2, 2014

(30) Foreign Application Priority Data
May 2, 2013 (TW) 102208134

(51) Int. Cl. A61H 23/00

(52) U.S. Cl. CPC A61H 23/008
USPC 601/76

(57) ABSTRACT

A pouch containing liquid with a therapeutic effect may include a main body and liquid. The main body is made by soft materials and having a receiving space used to receive the liquid. A carrier is used to dispose on a human body and includes a receiving section to receive the pouch. In an exemplary embodiment, the liquid is water that has been processed and the therapeutic effect results from an energy dispersed by the resonance of the water molecules at a predetermined frequency.

### FIELD OF THE INVENTION

The present invention relates to a pouch, and more particularly to a pouch containing liquid with therapeutic effect.

### BACKGROUND OF THE INVENTION

When a person has been engaging with a repetitive labor-intensive work for a long period of time, he/she may suffer from sprain, joint inflammation or muscle strain in knees, wrists, neck and/or other joints. Common treatments include medication and applying ointment or patch. People suffering from muscle strain or sprain may choose not to take medicine because they are afraid of developing drug dependence or simply due to the resistance of the medication. Thus, using medicinal patches has become more and more popular when people suffer from sprain, joint inflammation or muscle strain.

In order to increase human muscle cells to absorb the pharmaceutical ingredient in the patch, some irritant agents are used to activate the injured portion to enhance the absorption of the pharmaceutical ingredient. However, every patient has different reaction to irritant agent, and some patients may develop skin burning, redness and other allergic conditions, such as skin lesions. Therefore, there remains a need for a new and improved technique to enhance the absorption of the pharmaceutical ingredient.

### SUMMARY OF THE INVENTION

The problem the present invention wants to solve is that in order to increase human muscle cells to absorb the pharmaceutical ingredient in the patch, some irritant agents are used to activate the injured portion to enhance the absorption of the pharmaceutical ingredient. However, every patient has different reaction to irritant agent, and some patients may develop skin burning, redness and other allergic conditions, such as skin lesions.

The present invention provides a pouch containing liquid with a therapeutic effect may include a main body and liquid. The main body is made by soft materials and having a receiving space. In one embodiment, the main body is made by PU or TPU. The main body also includes a handle. Since the main body is made by soft materials, it can be folded and easy to be stored. Also, the main body can be of any shape, including square and round. The receiving space is used to receive the liquid. A carrier is used to dispose on a human body and includes a receiving section to receive the pouch. In an exemplary embodiment, the liquid is water that has been processed and the therapeutic effect results from an energy dispersed by the resonance of the water molecules at a predetermined frequency.

In one embodiment, the carrier is a pillow, and the receiving section is near the human's head portion. The pouch can be inserted into the receiving section through an opening end thereof. In one embodiment, the pouch can be sealed in the receiving section. When a user's head portion is on the pillow, the liquid with a therapeutic effect can enhance the blood circulation and cell activities.

In another embodiment, the carrier is a bedding mattress, and the receiving section is near the human's body portion. The pouch can be inserted into the receiving section through an opening end thereof. In one embodiment, the pouch can be sealed in the receiving section. When a user's body portion is lying down on the bedding mattress, the liquid with a therapeutic effect can enhance the blood circulation and cell activities.

In a further embodiment, the carrier is a belt, and the receiving section is near the human's waist portion. The pouch can be inserted into the receiving section through an opening end thereof. In one embodiment, the pouch can be sealed in the receiving section. When a user's wears the belt near the waist, the liquid with a therapeutic effect can enhance the blood circulation and cell activities near the user's waist.

### BRIEF DESCRIPTION OF THE DRAWINGS

FIG. 1 illustrates a rectangular pouch containing liquid with therapeutic effect in the present invention.

FIG. 2 illustrates a round pouch containing liquid with therapeutic effect in the present invention.

FIG. 3 illustrates the pouch in the present invention that can be folded and stored.

FIG. 4 illustrates an exploded view of the pouch and carrier in the present invention.

FIG. 5 illustrates a schematic view of the pouch, bedding mattress as the carrier and the user lying thereon in the present invention.

FIG. 6 illustrates an exploded view of the pouch and the underwear as the carrier in the present invention.

FIG. 7 illustrates a schematic view of the pouch and the underwear as the carrier in the present invention when in use.

FIG. 8 illustrates an exploded view of the pouch and the belt as the carrier in the present invention.

FIG. 9 illustrates a schematic view of the pouch and the belt as the carrier in the present invention when in use.

FIG. 10 illustrates an exploded view of the pouch and the eye pad as the carrier in the present invention.

FIG. 11 illustrates a schematic view of the pouch and the eye pad as the carrier in the present invention when in use.

FIG. 12 illustrates a schematic view of the pouch and the coaster as the carrier in the present invention when in use.

FIG. 13 illustrates a schematic view of the pouch and the socks as the carrier in the present invention when in use.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

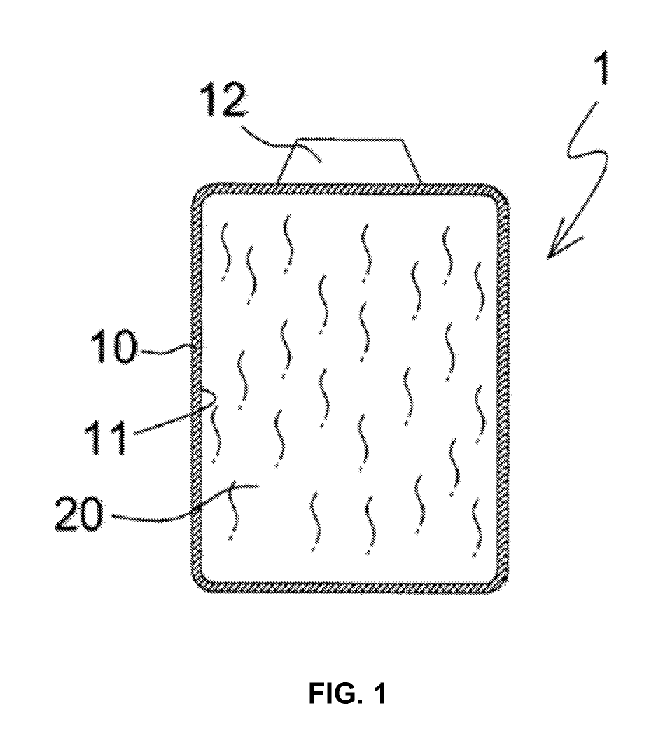

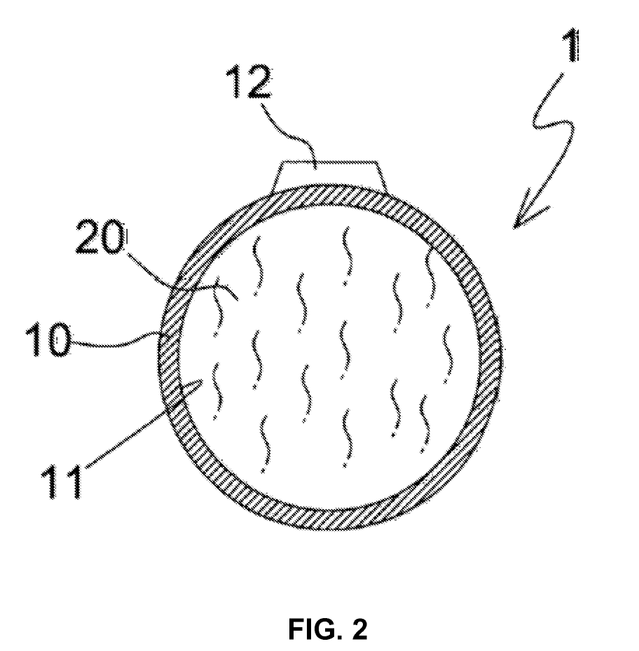

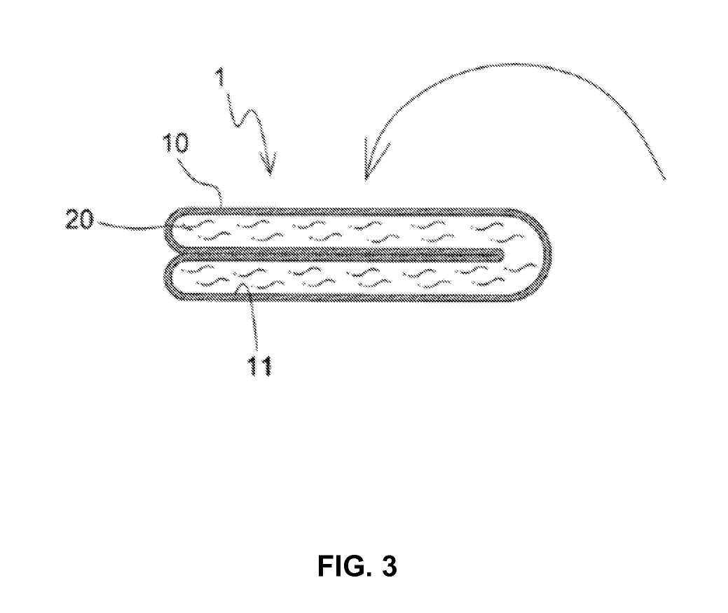

In one embodiment referring to FIGS. 1 to 4, a pouch (1) containing liquid with a therapeutic effect may include a main body (10) and liquid (20). The main body (10) is made by soft materials and having a receiving space (11). In one embodiment, the main body (10) is made by PU or TPU. The main body (10) also includes a handle (12). Since the main body (10) is made by soft materials, it can be folded and easy to be stored. Also, the main body (10) can be of any shape, including square and round. The receiving space (11) is used to receive the liquid (20). A carrier (30) is used to dispose on a human body and includes a receiving section (31) to receive the pouch (1). In an exemplary embodiment, the liquid (20) is water that has been processed and the therapeutic effect results from an energy dispersed by the resonance of the water molecules at a predetermined frequency.

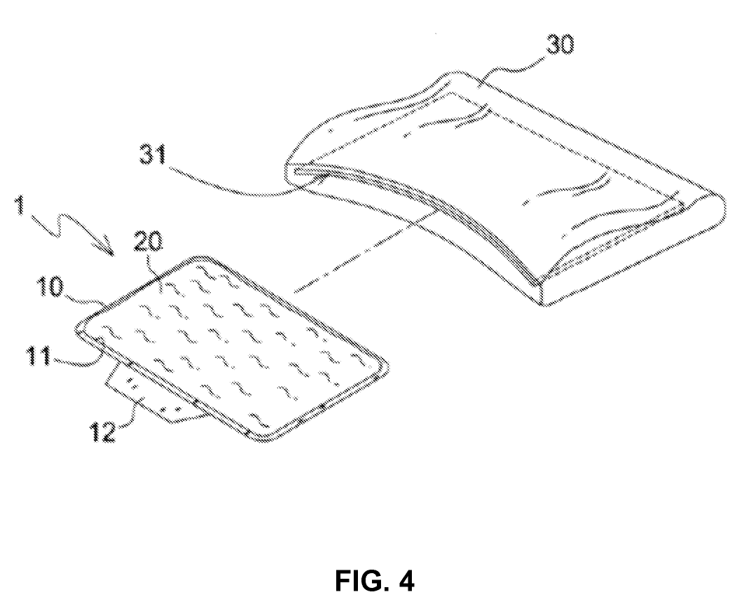

As shown in FIG. 4, the carrier (30) is a pillow, and the receiving section (31) is near the human's head portion. The pouch (1) can be inserted into the receiving section (31) through an opening end thereof. In one embodiment, the pouch (1) can be sealed in the receiving section (31). When a user's head portion is on the pillow, the liquid (20) with a therapeutic effect can enhance the blood circulation and cell activities.

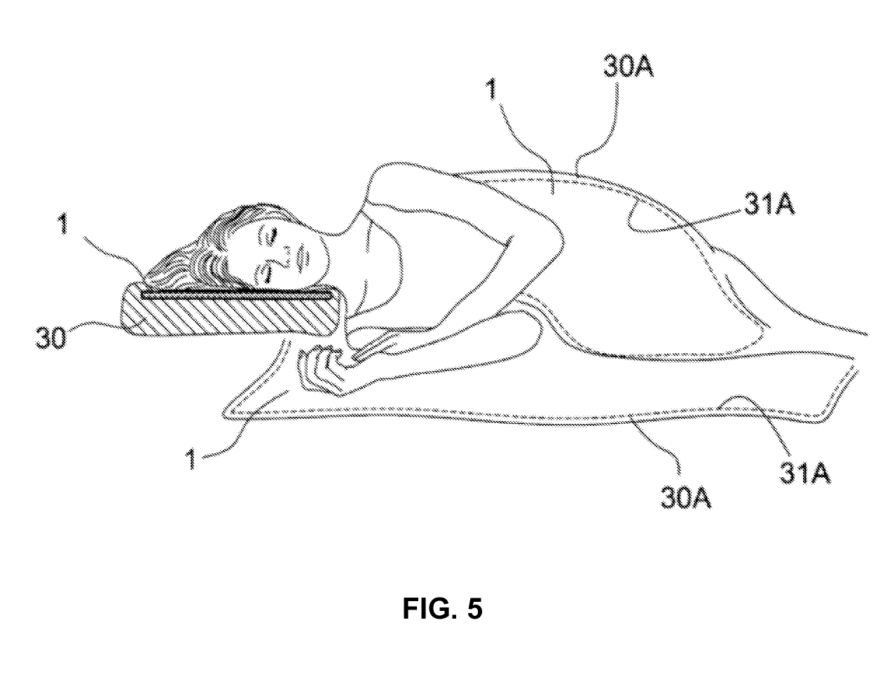

As shown in FIG. 5, the carrier (30A) is a bedding mattress, and the receiving section (30A) is near the human's body portion. The pouch (1) can be inserted into the receiving section (31A) through an opening end thereof. In one embodiment, the pouch (1) can be sealed in the receiving section (31A). When a user's body portion is lying down on the bedding mattress, the liquid (20) with a therapeutic effect can enhance the blood circulation and cell activities.

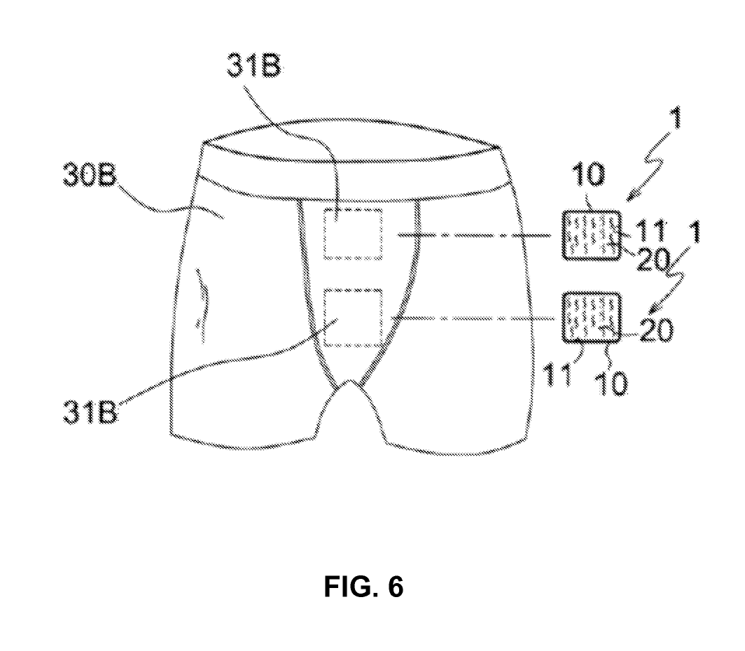

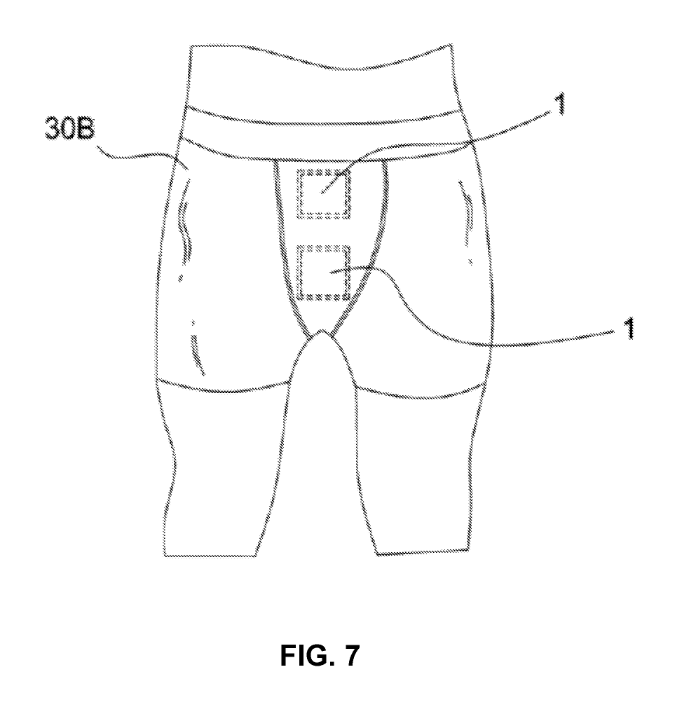

As shown in FIGS. 6 and 7, the carrier (30B) is underwear, and the receiving section (31B) is near the human's body portion. The pouch (1) can be inserted into the receiving section (31B) through an opening end thereof. In one embodiment, the pouch (1) can be sealed in the receiving section (31B). When a user's wears the underwear (30B), the liquid (20) with a therapeutic effect can enhance the blood circulation and cell activities.

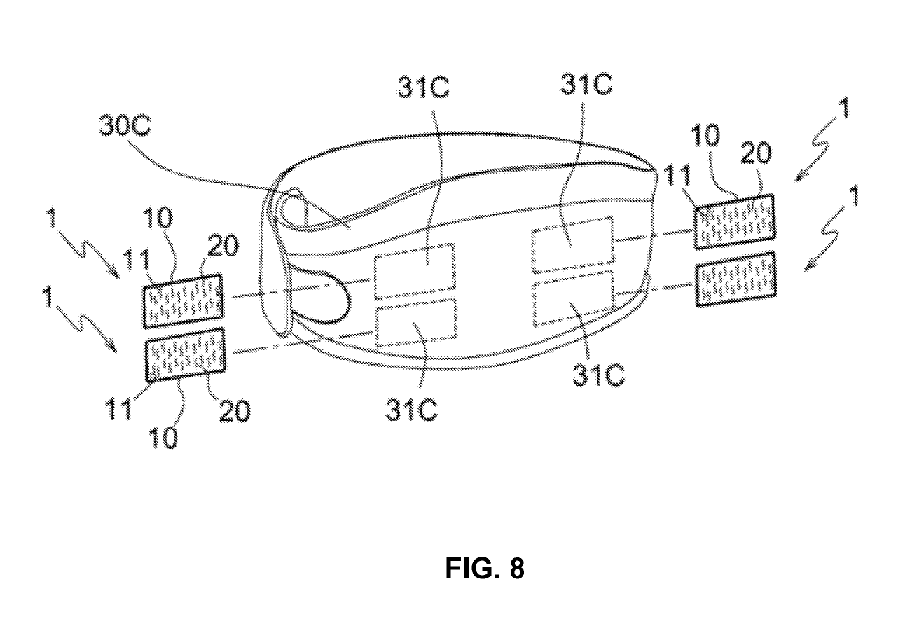

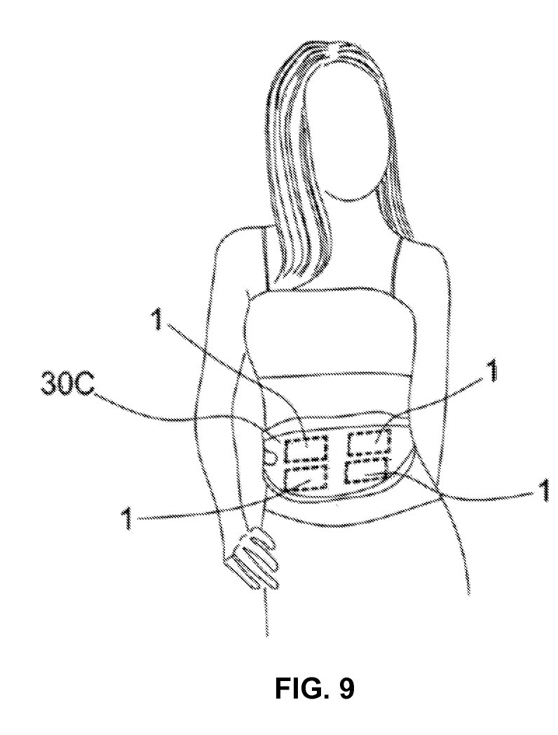

As shown in FIGS. 8 and 9, the carrier (30C) is a belt, and the receiving section (31C) is near the human's waist portion. The pouch (1) can be inserted into the receiving section (31C) through an opening end thereof. In one embodiment, the pouch (1) can be sealed in the receiving section (31C). When a user's wears the belt (30C) near the waist, the liquid (20) with a therapeutic effect can enhance the blood circulation and cell activities near the user's waist.

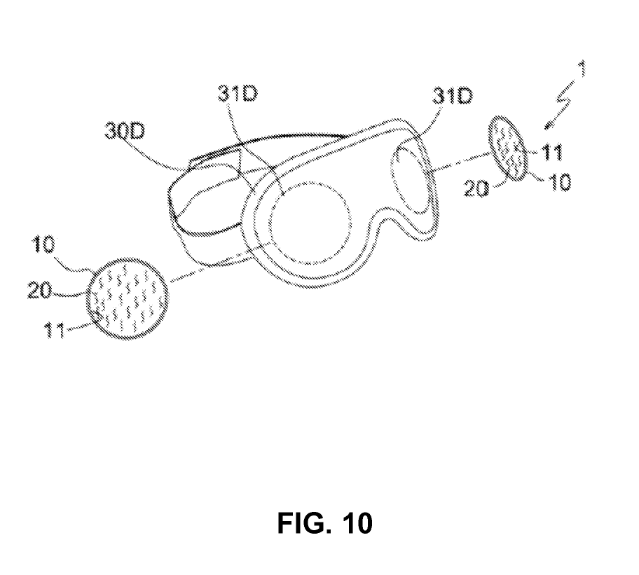

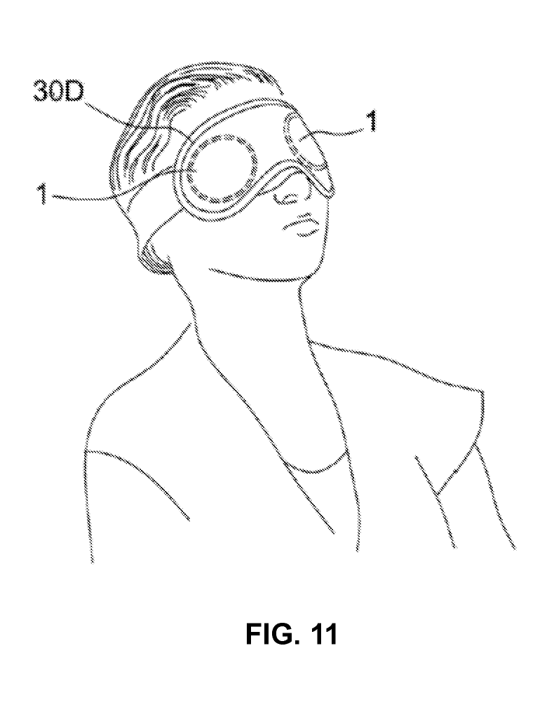

As shown in FIGS. 10 and 11, the carrier (30D) is an eye pad, and the receiving section (31D) is near the human's eyes. The pouch (1) can be inserted into the receiving section (31D) through an opening end thereof. In one embodiment, the pouch (1) can be sealed in the receiving section (31D). When a user's wears the eye pad (30D) near the user's eyes, the liquid (20) with a therapeutic effect can enhance the blood circulation and cell activities near the user's eyes.

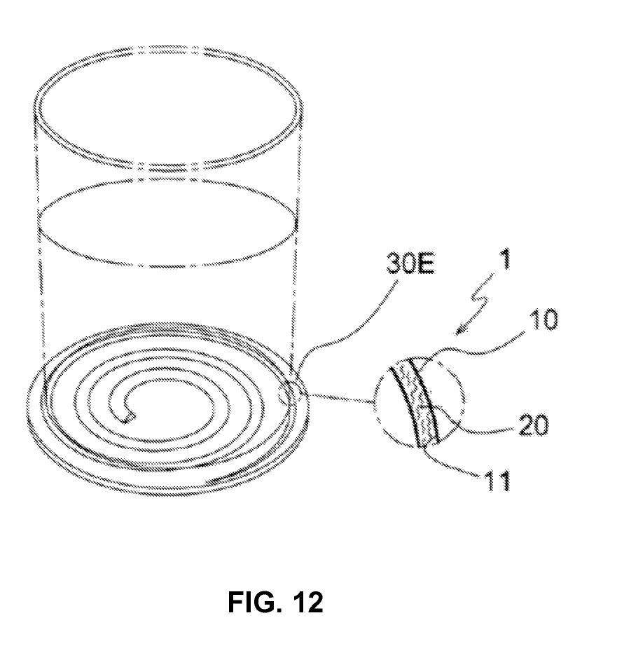

As shown in FIG. 12, the carrier (30E) is a coaster, and the spiral main body (10) is closed to a position of the disposition of a cup. When the cup contacts with the coaster, the liquid (20) can activate the water molecules in the cup to soften the water and enhance the quality of the water.

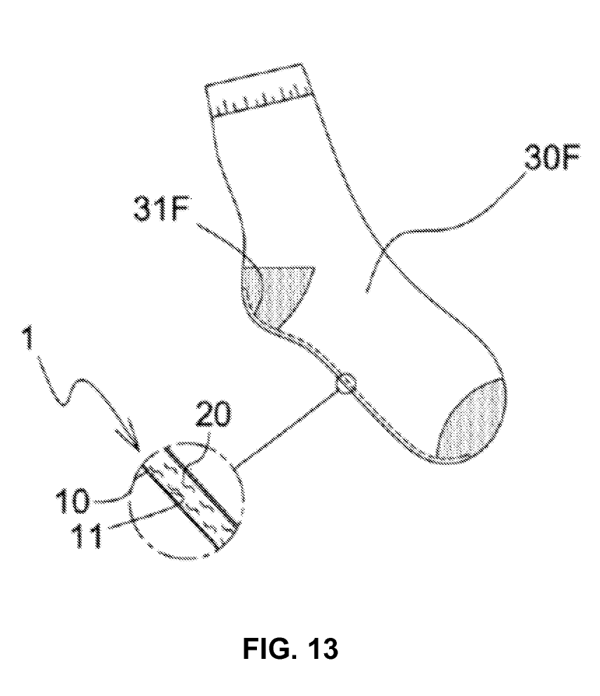

As shown in FIG. 13, the carrier (30F) is a pair of socks, and the receiving section (31F) of each sock is near the human's feet. The pouch (1) can be inserted into the receiving section (31F) through an opening end thereof. In one embodiment, the pouch (1) can be sealed in the receiving section (31F). When a user's wears the socks (30F), the liquid (20) with a therapeutic effect can enhance the blood circulation and cell activities near the user's feet.

According to the embodiments stated above, the liquid (20) enclosed in the main body (10) is configured to disperse energy to provide therapeutic effect. The pouch (1) can be inserted into the receiving section (31) of the carrier (30) through an opening end thereof. And the energy dispersed by the liquid (20) can enhance the user's blood circulation and cell activities on various portions of the user's body.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A pouch containing liquid with a therapeutic effect comprising a main body made by soft materials and having a receiving space; and the liquid being processed so the molecules thereof resonating at a predetermined frequency to produce the therapeutic effect, wherein the liquid is received in the receiving space of the main body, and a carrier is used to dispose on or around a user's body and including a receiving section to receive the pouch.

2. The pouch containing liquid with a therapeutic effect of claim 1, wherein the liquid is water.

3. The pouch containing liquid with a therapeutic effect of claim 1, wherein a handle is formed on one side of the pouch.

4. The pouch containing liquid with a therapeutic effect of claim 1, wherein the carrier is a pillow.

5. The pouch containing liquid with a therapeutic effect of claim 1, wherein the carrier is a belt.

6. The pouch containing liquid with a therapeutic effect of claim 1, wherein the carrier is an eye pad.

7. The pouch containing liquid with a therapeutic effect of claim 1, wherein the carrier is a pair of socks.

8. The pouch containing liquid with a therapeutic effect of claim 1, wherein the carrier is a coaster.

9. The pouch containing liquid with a therapeutic effect of claim 1, wherein the carrier is underwear.
